(19) United States
(12) Patent Application Publication
(10) Pub. No.: US 2012/0278204 A1
(43) Pub. Date: Nov. 1, 2012

(54) DEVICE FOR SUPPORTING GOODS DELIVERY SCHEDULE COORDINATION AND METHOD OF SUPPORTING GOODS DELIVERY SCHEDULE COORDINATION

(75) Inventors: Maho URANO, Hadano (JP); Takahiro OGAWA, Yokohama (JP); Takanari INOUE, Odawara (JP); Satoshi KATSUBE, Fujisawa (JP)

(73) Assignee: Hitachi, Ltd.

(21) Appl. No.: 13/364,348

(22) Filed: Feb. 2, 2012

(30) Foreign Application Priority Data
Apr. 26, 2011 (JP) 2011-098416

(51) Int. Cl. G06Q 10/08; G06Q 30/00

(52) U.S. Cl. 705/28; 705/330

(57) ABSTRACT

A device for supporting goods delivery schedule coordination includes: a storage unit retaining information of a delivery schedule and transportation lead time; a computation unit having a transportation lead-time converting unit which calculates the shipment date in the delivery schedule and stores that as an updated delivery schedule; an output unit which outputs by a screen the information of the updated delivery schedule based on two types of timing of arrival-date basis and shipment-date basis; and a control unit having a schedule-coordination-information receiving unit which receives information of the delivery schedule requested to be coordinated and stores that as a coordination-requested schedule. The computation unit further has a schedule-coordinatable-period calculating unit which stores the delivery schedule included in the coordinatable period as a coordinatable period. The output unit distinguishably displays a range about the coordinatable period.

### CROSS-REFERENCE TO RELATED APPLICATION

The present application claims priority from Japanese Patent Application No. 2011-098416 filed on Apr. 26, 2011, the content of which is hereby incorporated by reference into this application.

### TECHNICAL FIELD OF THE INVENTION

The present invention relates to a technique for managing purchase/delivery of goods by, for example, companies. The present invention particularly relates to a technique effectively applied to a device for supporting goods delivery schedule coordination and a method of supporting goods delivery schedule coordination for planning/coordinating delivery schedules about delivery of goods to delivery destinations.

### BACKGROUND OF THE INVENTION

For example, in a company or the like having a plurality of factories and for forth, the schedule coordinating operation of appropriately planning/coordinating the delivery schedule (time and date, quantity, transportation means, etc.) about purchase and shipment of parts, etc. from suppliers and delivery to the factories by a purchase supervisor (a person who supervises/coordinates the schedule for delivery to one or more factories or the like) is important for appropriate production management and stock management in the factories. In order to achieve accuracy or promptness of the managements or to reduce the operation load of the purchase supervisor, the schedule coordinating operation has been supported by information processing systems.

As a technique related to the support of schedule coordinating operation, for example, Japanese Patent Application Laid-Open Publication No. 2010-61317 (Patent Document 1) describes a forecast management system as described below. The forecast management system has: storage means for storing product codes for identifying finished products, part codes, and information of parts; unordered information presenting means for presenting information of unordered parts including required deadlines of individual parts; actual order information presenting means for presenting the information of parts including actually ordered required deadline by using the part codes; and a disclosing means which discloses the information of these parts. The disclosing means discloses any of the selected information among: information of outstanding-order parts which have already been ordered and not delivered yet; information of parts which have not been ordered and planned to be ordered; information of the parts integrating the outstanding-order parts and the parts to be ordered; and information of a list of the information of these parts, thereby enabling selection and display of forecast information and reduction in the order lead time of the parts.

### SUMMARY OF THE INVENTION

However, in the above-described technique of Patent Document 1, forecasting is managed only by the information of one kind of timing that “when the part is required to arrive at the factory”. Therefore, the technique of Patent Document 1 cannot also take other different timing into consideration to manage the delivery schedule. In other words, it is not possible to instantaneously determine whether an coordinated delivery schedule is executable or not based on two types of timing, i.e., when the purchase supervisor changes or coordinate the delivery schedule, timing when the part is shipped from a supplier (hereinafter, this timing may be referred to as “shipment-date basis”) and timing when a part arrives at a factory (hereinafter, this timing may be referred to as “arrival-date basis”).

Also, in the case of changing a delivery schedule of a certain factory, a deadline until which the supplier has to ship the part cannot be instantly determined. Furthermore, in the case of carrying out schedule coordination between one or more factories and one or more suppliers, transportation lead time is different in every combination of the factory and the supplier, and there are a plurality of transportation means; therefore, there are a huge number of coordination patterns.

In other words, these problems can be explained that it is difficult for a user to organically associate information of the necessary amount or amount of margin of parts and a delivery schedule of each factory with information of the shipment schedule and shipping performance of each supplier and to instantly determine whether the delivery schedule is executable or not or how long the range that can be coordinated.

Under such circumstances, the time required for the schedule coordinating operation of the purchase supervisor becomes long, and the risk of causing deterioration in the schedule accuracy such as an increase in emergency transportation cost caused by, for example, overlooking coordinatable schedule is increased. Furthermore, there is also a problem that the purchase supervisor cannot check the result of schedule coordination at the same time with the supplier who is at a base different from that of the supervisor, and the schedule coordinating operation cannot be efficiently carried out in a short period of time.

A preferred aim of the present invention is to provide a device for supporting goods delivery schedule coordination and a method of supporting goods delivery schedule coordination that carry out supporting so as to enable a purchase supervisor to highly-accurately plan/coordinate delivery schedules within a short period of time by a mechanism that manages delivery schedules of goods based on two types of timing of “arrival-date basis” and “shipment-date basis” and enables easy distinguishing of coordinatable delivery schedules.

The above and other preferred aims and novel characteristics of the present invention will be apparent from the description of the present specification and the accompanying drawings.

The typical ones of the inventions disclosed in the present application will be briefly described as follows.

That is, a device for supporting goods delivery schedule coordination supporting coordination of a delivery schedule about delivery of goods from a supplier to a delivery destination, the device comprising: a storage unit retaining information of the delivery schedule about when and how many of the goods are planned to be delivered to the delivery destination by the supplier, and information of transportation lead time defining, with respect to each of transportation means, a lead time taken upon transportation of the goods from the supplier to the delivery destination; a computation unit having a transportation lead-time converting unit calculating a shipment date by counting backward from a date of arrival at the delivery destination in the delivery schedule by a number of days of the corresponding transportation lead time based on the information of the delivery schedule and the information of the transportation lead time, and adding the information of the calculated shipment date to the delivery schedule and storing the information into the storage unit as an updated delivery schedule; and a control unit having an output unit outputting by a screen the information of the updated delivery schedule based on two types of timing of arrival-date basis regarding when the goods arrive at the delivery destination and shipment-date basis regarding when the goods are shipped from the supplier, and a schedule-coordination-information receiving unit receiving from a user the information of the delivery schedule for which coordination is requested via the screen and storing the information of the delivery schedule into the storage unit as a coordination requested schedule.

The computation unit further has a schedule-coordinatable-period calculating unit calculating a period coordinatable with respect to the delivery schedule for which coordination is requested by the user based on the information of the updated delivery schedule, the information of the coordination requested schedule, and the information of the transportation lead time, extracting the delivery schedule included in the period, and storing the extracted schedule into the storage unit as a coordinatable period. The output unit of the control unit displaying a range about the coordinatable period distinguishably on the screen.

Also, the present invention can be applied to a method of supporting goods delivery schedule coordination and recording media recoding a program for making a computer as a device for supporting goods delivery schedule coordination.

The effects obtained by typical aspects of the present invention will be briefly described below.

According to a typical embodiment of the present invention, when delivery schedules of goods are managed based on two types of timing of “arrival-date basis” and “shipment-date basis” to enable easy distinguishing of coordinatable delivery schedules, a purchase supervisor can be supported so as to be able to plan/coordinate delivery schedules highly accurately within a short period of time.

### BRIEF DESCRIPTIONS OF THE DRAWINGS

FIG. 1 is a diagram showing an outline of a configuration example of a device for supporting goods delivery schedule coordination which is an embodiment of the present invention;

FIG. 2 is a diagram showing a hardware configuration example of the device for supporting goods delivery schedule coordination according to the embodiment of the present invention;

FIG. 3 is a flowchart showing an example of a flow of a process in which a purchase supervisor carries out a schedule coordinating operation by utilizing the device for supporting goods delivery schedule coordination according to the embodiment of the present invention;

FIG. 4 is a diagram showing an example of information which is retained in external information and can be obtained by the device for supporting goods delivery schedule coordination according to the embodiment of the present invention;

FIG. 5 is a diagram showing a data configuration of a delivery schedule and an example of specific data according to the embodiment of the present invention;

FIG. 6 is a diagram showing a data configuration of transportation lead time and an example of specific data according to the embodiment of the present invention;

FIG. 7 is a diagram showing a data configuration of updated delivery schedule and an example of specific data according to the embodiment of the present invention;

FIG. 8 is a diagram showing an example of a delivery schedule coordinating screen for checking delivery schedules according to the embodiment of the present invention;

FIG. 9 is a diagram showing a data configuration of a coordination requested schedule and an example of specific data according to the embodiment of the present invention;

FIG. 10 is a diagram showing a data configuration of a coordinatable period and an example of specific data according to the embodiment of the present invention;

FIG. 11 is a diagram showing a data configuration of a factory stock forecast and an example of specific data according to the embodiment of the present invention;

FIG. 12 is a diagram showing a data configuration of procurement lead time and specific data according to the embodiment of the present invention;

FIG. 13 is a diagram showing an outline of an example of a method of calculating available stocks according to the embodiment of the present invention;

FIG. 14 is a diagram showing a data configuration of available stocks and an example of specific data according to the embodiment of the present invention;

FIG. 15 is a diagram showing a data configuration of a coordinatable schedule and an example of specific data according to the embodiment of the present invention;

FIG. 16 is a diagram showing a data configuration of a supplier stock schedule and an example of specific data according to the embodiment of the present invention;

FIG. 17 is a diagram showing an example of a delivery schedule coordinating screen for checking and coordinating delivery schedules according to the embodiment of the present invention;

FIG. 18 is a diagram showing another example of the delivery schedule coordinating screen for checking and coordinating delivery schedules according to the embodiment of the present invention;

FIG. 19 is a diagram showing an example of a data configuration of a changed schedule and specific data according to the embodiment of the present invention;

FIG. 20 is a diagram showing a data configuration of transportation cost and an example of specific data according to the embodiment of the present invention; and

FIG. 21 is a diagram showing a KPI display screen for displaying KPI according to the embodiment of the present invention.

### DESCRIPTIONS OF THE PREFERRED EMBODIMENT

Hereinafter, embodiments of the present invention will be described in detail with reference to the accompanying drawings. Note that components having the same function are denoted by the same reference symbols in principle throughout the drawings for describing the embodiment, and the repetitive description thereof will be omitted.

A device for supporting goods delivery schedule coordination which is an embodiment of the present invention is directed to an operation of managing delivery of parts to factories as an example. When a purchase supervisor is to change/coordinate a schedule of delivery to a certain factory, necessary delivery schedules of factories and suppliers are displayed, and information of a period in which the delivery schedule can be changed/coordinated, quantity, and transportation means is displayed, thereby supporting the schedule coordinating operation of the purchase supervisor.

<Device Configuration>

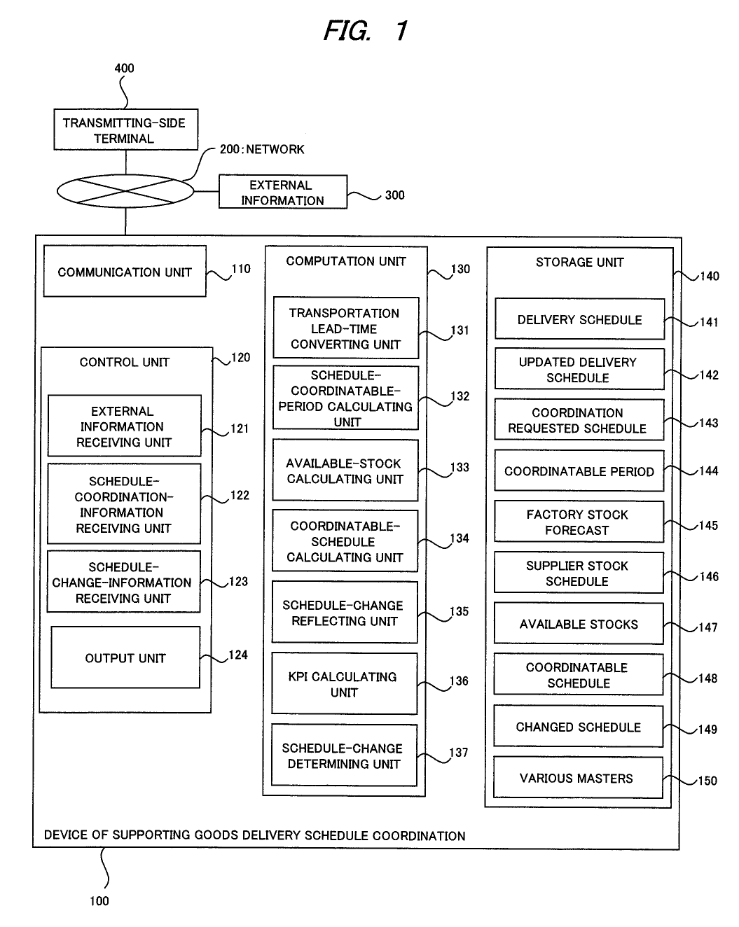

FIG. 1 is a diagram showing an outline of a configuration example of a device for supporting goods delivery schedule coordination which is an embodiment of the present invention. A device for supporting goods delivery schedule coordination 100 is implemented by a calculator such as a PC (personal computer), workstation, or server device and is composed of a communication unit 110, a control unit 120, a computation unit 130, and a storage unit 140.

The control unit 120 is implemented by software and is composed of, for example, an external information receiving unit 121, a schedule-coordination-information receiving unit 122, a schedule-change information receiving unit 123, and an output unit 124. The computation unit 130 is similarly implemented by software and is composed of, for example, a transportation lead-time converting unit 131, a schedule-coordinatable-period calculating unit 132, an available-stock calculating unit 133, a coordinatable-schedule calculating unit 134, a schedule-change reflecting unit 135, a KPI (Key Performance Indicator) calculating unit 136, and a schedule-change determining unit 137.

The storage unit 140 is implemented by, for example, a database, file, or memory table and retains data of, for example, a delivery schedule 141, an updated delivery schedule 142, a coordination requested schedule 143, a coordinatable period 144, factory stock forecast 145, a supplier stock schedule 146, available stocks 147, a coordinatable schedule 148, a changed schedule 149, and various masters 150.

Among the information pieces necessary for processing of the computation unit 130, as to information not retaining latest information in the storage unit 140 in advance, data may be obtained from external information 300 composed of a database server or the like or from a transmitting-side terminal 400 composed of a PC or the like via a network 200 while using the communication unit 110 as an interface to update the contents of the storage unit 140. Normally, a communication network such as a LAN (Local Area Network) is conceivable as the network 200, but not limited thereto. The network may be a public communication network such as the Internet or a communication network partly using a general public line such as a WAN (Wide Area Network) or VPN (Virtual Private Network).

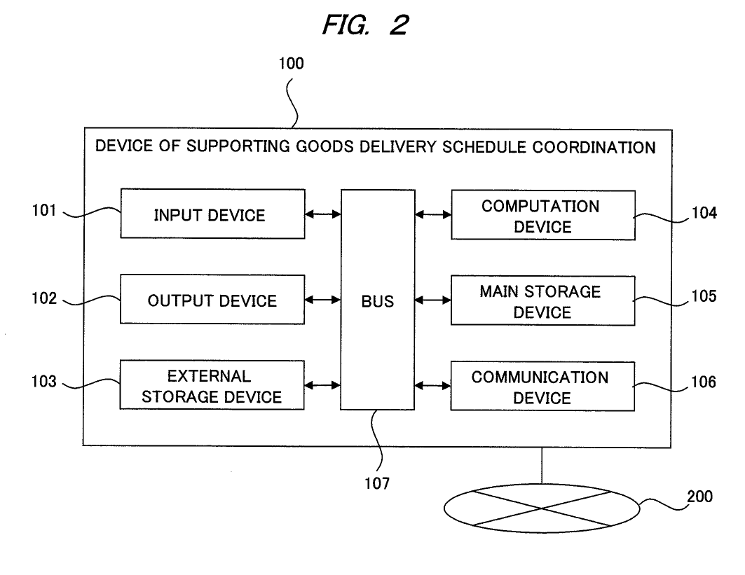

FIG. 2 is a diagram showing a hardware configuration example of the device for supporting goods delivery schedule coordination 100. The device for supporting goods delivery schedule coordination 100 has a configuration similar to the configuration owned by general computer equipment and has, for example, as a hardware configuration, an input device 101, an output device 102, an external storage device 103, a computation device 104, a main storage device 105, a communication device 106, and a bus 107 mutually connecting the devices.

The input device 101 is a device which receives inputs such as a keyboard, a mouse, a stylus pen, or a different pointing device. The output device 102 is a device which carries out display such as a display. The external storage device 103 is a non-volatile storage device such as a hard disk device or a flash memory. The computation device 104 is a computation device such as a CPU (Central Processing Unit). The main storage device 105 is a memory device such as a RAM (Random Access Memory). The communication device 106 is a wired communication device, which carries out wire communication via a network cable, or a wireless communication device, which carries out wireless communication via an antenna.

The storage unit 140 of the device for supporting goods delivery schedule coordination 100 shown in FIG. 1 is achieved by the external storage device 103 or the main storage device 105 in the hardware configuration shown in FIG. 2. Similarly, the control unit 120 and the computation unit 130 of the device for supporting goods delivery schedule coordination 100 shown in FIG. 1 are achieved by a software program, which causes the computation device 104 in the hardware configuration shown in FIG. 2 to carry out processing. Similarly, the communication unit 110 of the device for supporting goods delivery schedule coordination 100 shown in FIG. 1 is achieved by a software program, which causes the computation device 104 in the hardware configuration shown in FIG. 2 to carry out processing, and the communication device 106.

The software programs executed in the device for supporting goods delivery schedule coordination 100 of the present embodiment are stored in the external storage device 103 or in the main storage device 105, and, upon execution, the programs are loaded to the main storage device 105 and executed by the computation device 104. These programs may be provided in the manner that they are recorded in a computer readable recording medium such as a CD-ROM (Compact Disc Read Only Memory), a flexible disk (Flexible Disk), a CD-R (Compact Disc Recordable), or a DVD (Digital Versatile Disc) as a file in an installable format or an executable format.

Furthermore, the programs executed in the device for supporting goods delivery schedule coordination 100 of the present embodiment may be provided by storing the programs in a computer connected to the network 200 such as the Internet and downloading the programs via the network 200. The programs executed in the device for supporting goods delivery schedule coordination 100 of the present embodiment may be provided or distributed via the network 200 such as the Internet or provided by incorporating the programs in the external storage device 103 such as a ROM in advance.

<Process Flow>

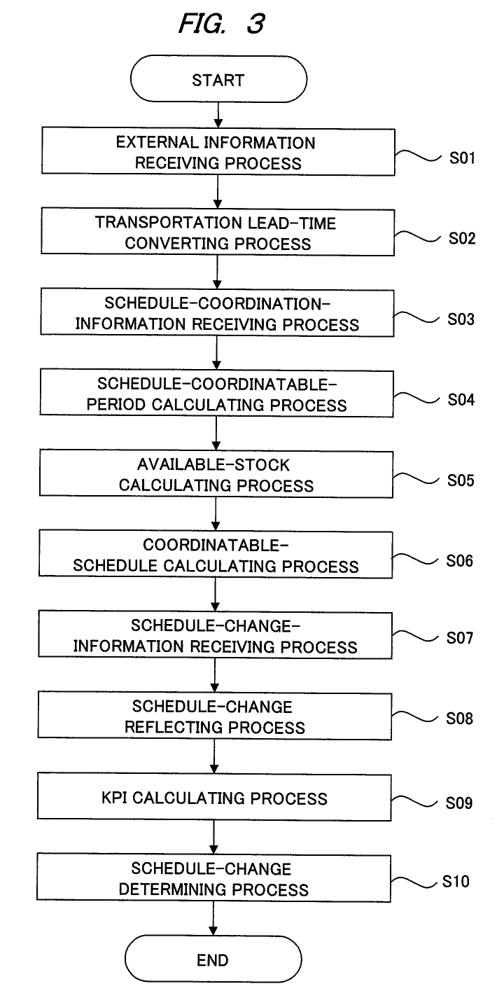

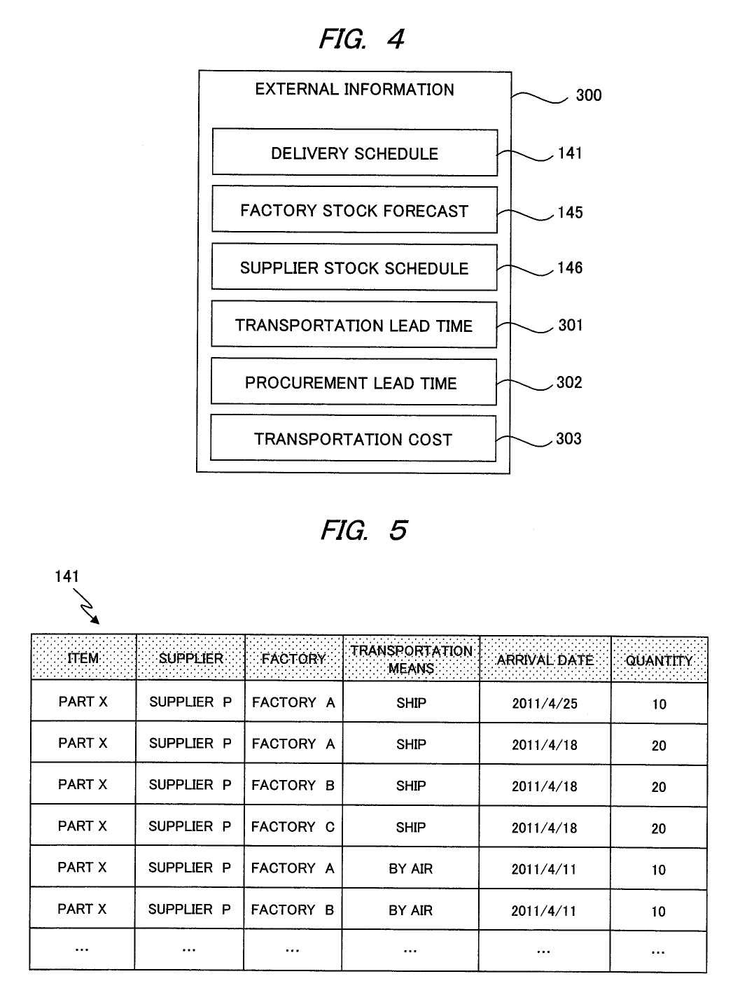

FIG. 3 is a flowchart showing an example of a flow of a process when a purchase supervisor carries out a schedule coordinating operation by utilizing the device for supporting goods delivery schedule coordination 100. First, the external information receiving unit 121 of the control unit 120 obtains various necessary information from the external information 300 composed of a database server or the like or receives an input and executes an external information receiving process of storing the information in the storage unit 140 (S01). FIG. 4 is a diagram showing an example of the information which is retained in the external information 300 and can be obtained by the device for supporting goods delivery schedule coordination 100. The external information 300 retains information such as: the delivery schedule 141, the factory stock forecast 145, the supplier stock schedule 146, transportation lead time 301, procurement lead time 302, and transportation cost 303.

The delivery schedule 141 is information of a current delivery schedule before coordination and is information about each of items about when and how many parts are to be delivered by each of suppliers. The factory stock forecast 145 is information about each of the items about when and how many the parts are forecasted to be owned as stocks by each of factories. The supplier stock schedule 146 is information about each of the items about when and how many parts are scheduled to be owned as stocks by each of the suppliers.

The transportation lead time 301 is information defining a lead time, which is taken upon transportation from each supplier to each factory, with respect to each of transportation means and the procurement lead time 302 is information defining a lead time necessary for each of the suppliers to procure materials or the like of the parts and manufacture and ship the parts. The transportation cost 303 is information defining cost, which is taken upon transportation from each supplier to each factory, with respect to each of the transportation means. The information of the external information 300 is sometimes generated/managed by, for example, a different existing production management system or stock management system.

The external information receiving unit 121 obtains the external information and stores the information into the storage unit 140. In the present embodiment, the transportation lead time 301, the procurement lead time 302, and the transportation cost 303 are stored in the various masters 150 of the storage unit 140 as master information. If the latest information of the above-described information retained in the external information 300 has already been retained in the storage unit 140, processes may be skipped in accordance with needs.

Returning to FIG. 3, then, based on the delivery schedule 141 of the storage unit 140 and the information of the transportation lead time 301 of the various masters 150, the transportation lead-time converting unit 131 of the computation unit 130 executes a transportation lead-time converting process of calculating the data of shipment from the supplier for each delivery schedule and adding this information to the delivery schedule to store the information as the updated delivery schedule 142 in the storage unit 140 (S02).

FIG. 5 is a diagram showing a data configuration of the delivery schedule 141 and an example of specific data. As described above, the delivery schedule 141 retains information about each item about when and how many parts are planned to be delivered to each factory by each supplier as the information of a current delivery schedule. For example, the delivery schedule 141 is formed as a table having articles such as “ITEM”, “SUPPLIER”, “FACTORY”, “TRANSPORTATION MEANS”, “ARRIVAL DATE”, and “QUANTITY”.

The article of “ITEM” retains information such as names or model numbers which identify the items of objective parts. The article of “SUPPLIER” retains information such as names or IDs which identify the suppliers who ship the objective parts. The article of “FACTORY” retains information such as names or IDs which identify the factories to which the objective parts are delivered. The article of “TRANSPORTATION MEANS” retains information which identifies means used upon transportation of the objective parts from the supplier to the factory. The article of “ARRIVAL DATE” retains information of the planned date when the objective parts arrive at (delivered to) the factory. The article of “QUANTITY” retains the information of the quantity of the case in which the objective parts are delivered to the factory.

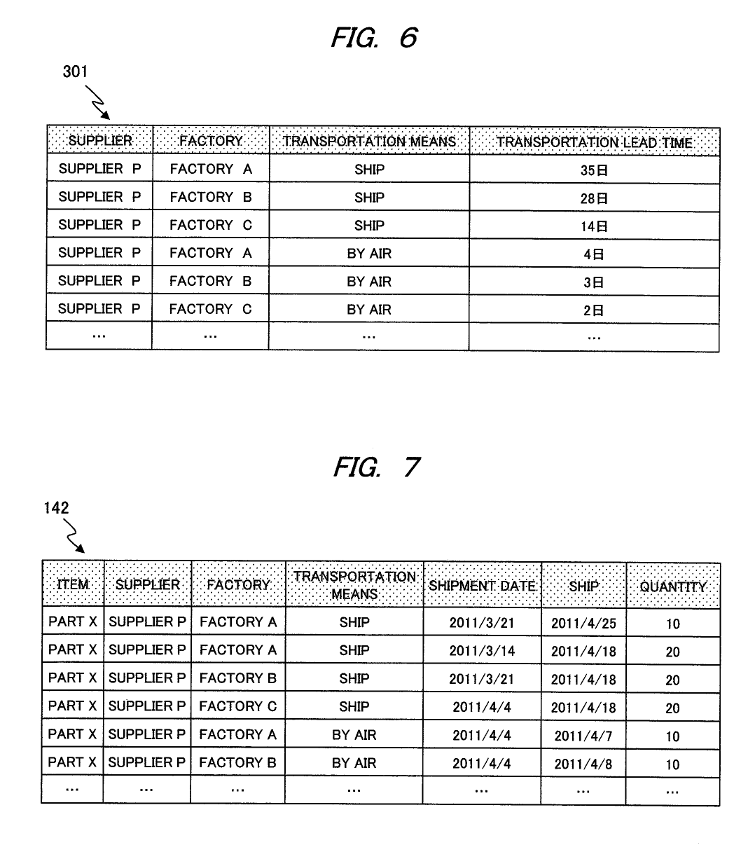

FIG. 6 is a diagram showing a data configuration of the transportation lead time 301 and an example of specific data. As described above, the transportation lead time 301 retains information defining a lead time, which is taken upon transportation of the parts from each supplier to each factory, with respect to each of the transportation means and is formed as, for example, a table having articles such as “SUPPLIER”, “FACTORY”, “TRANSPORTATION MEANS”, and “TRANSPORTATION LEAD TIME”. The article of “TRANSPORTATION LEAD TIME” retains information of a lead time required from shipment of the part by the objective supplier until transportation to the factory.

Based on the above-described information of the delivery schedule 141 and the transportation lead time 301, the shipment date is calculated by counting backward the days of the transportation lead time from the date of arrival at the factory in each delivery schedule, and the updated delivery schedule 142 including each delivery schedule to which the information of the shipment date is added is stored. FIG. 7 is a diagram showing a data configuration of the updated delivery schedule 142 and an example of specific data. As described above, the updated delivery schedule 142 retains each of delivery schedules to which the information of the date of shipment from the supplier is added. The updated delivery schedule 142 is formed as a table having the article of “SHIPMENT DATE” in addition to the data configuration similar to the delivery schedule 141 shown in FIG. 5. The article of “SHIPMENT DATE” retains the information of the date indicating when the objective part is to be shipped from the supplier.

The information of the updated delivery schedule 142 is output to a screen by the output unit 124 of the control unit 120 so that a user such as a purchase supervisor can check the delivery schedules in parallel based on the two types of timing, i.e., “arrival-date basis” and “shipment-date basis”.

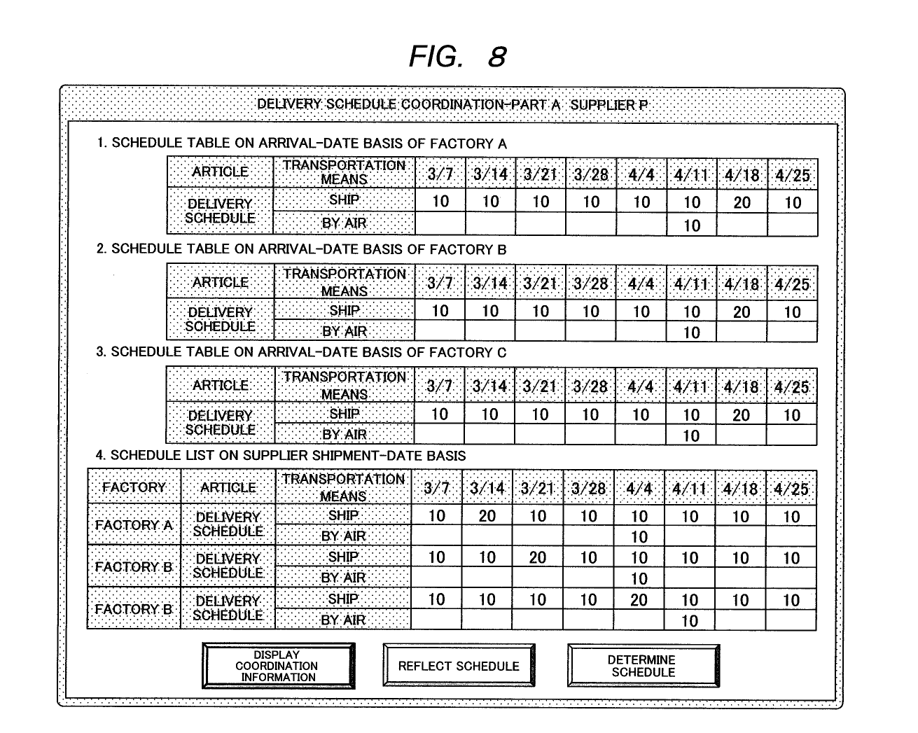

FIG. 8 is a diagram showing an example of a delivery schedule coordinating screen for checking delivery schedules. Herein, for example, about the schedule of delivery of a part (for example, “PART A”), which is specified by a user, from a specified supplier (for example, “SUPPLIER P”), delivery schedules (how many parts are to be delivered on which day) on “arrival-date basis” are shown with respect to each factories (and with respect to each of transportation means) in schedule tables of 1 to 3 sequentially from the top. In a schedule list of 4, the delivery schedule (how many parts are to be shipped on which day) on “shipment-date basis” is shown by a list with respect to each of the factories (and transportation means).

As a matter of course, the format of the table shown in FIG. 8 is merely an example, and a different display format may be used. For example, the schedule tables of 1 to 3 in the drawing may be united and displayed as one table, or the schedule list of 4 may be displayed in a manner that it is divided into a plurality of tables. In the example of FIG. 8, the date of the horizontal axis in the delivery schedules is shown on a week basis, but is not particularly limited thereto; and the date can be displayed, for example, on a day basis or a month basis. In the example of FIG. 8, a delivery schedule of the “arrival-date basis” and a delivery schedule of the “shipment-date basis” are displayed so that they can be viewed in the same screen; however, for example, they may be alternately switched and displayed as different sheets or screens.

Each screen including the screen and displayed by the device for supporting goods delivery schedule coordination 100 may be displayed on the output device 102 of the device for supporting goods delivery schedule coordination 100 in FIG. 2 or may be displayed by, for example, a Web browser while utilizing, for example, a Web server program, which is not shown, and using the transmitting-side terminal 400 in FIG. 1 as a client.

Returning to FIG. 3, then, the schedule-coordination-information receiving unit 122 of the control unit 120 executes a schedule-coordination-information receiving process of receiving information of a coordination-requested delivery schedule from a user via the above-described delivery schedule coordinating screen and storing the information as the coordination-requested schedule 143 of the storage unit 140 (S03). Herein, for example, after the user gives an instruction, for example, by selecting a part (for example, date of the arrival date or the like) requested to coordinate the delivery schedule in the delivery-schedule coordinating screen shown in FIG. 8, a coordination request is received when “COORDINATION INFORMATION DISPLAY” button in the lower part of the screen is touched. The received information is recoded in the coordination requested schedule 143 by the schedule-coordination-information receiving unit 122.

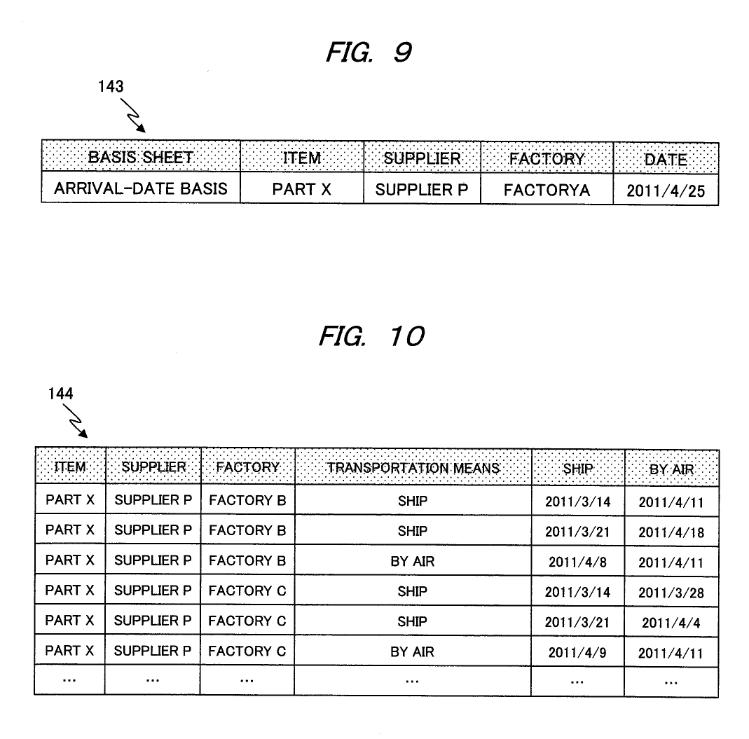

FIG. 9 is a diagram showing a data configuration of the coordination requested schedule 143 and an example of specific data. The coordination requested schedule 143 retains information of a delivery schedule requested by the user to be changed/coordinated. The coordination requested schedule 143 is formed as a table having articles such as “BASIS SHEET”, “ITEM”, “SUPPLIER”, “FACTORY”, and “DATE”.

The article of “BASIS SHEET” retains information that identifies whether the delivery schedule of a coordination target has been selected by a user by, for example, either screen or sheet of “arrival-date basis” or “shipment-date basis” in the delivery-schedule coordinating screen shown in FIG. 8. The article of “DATE” retains information of a date of the coordination request in the delivery schedule of the coordination request. Herein, if the value of the article “BASIS SHEET” is “ARRIVAL-DATE BASIS”, the information of the date of arrival at the factory is retained; and, if “SHIPMENT-DATE BASIS”, the information of the date of shipment from the suppliers is retained.

Returning to FIG. 3, then, based on the information of the updated delivery schedule 142, the coordination requested schedule 143, and the transportation lead time 301, the schedule-coordinatable-period calculating unit 132 of the computation unit 130 executes a schedule-coordinatable-period calculating process of calculating a coordinatable period with respect to the coordination-requested delivery schedule, extracting the delivery schedule included in the period, and storing that in the coordinatable period 144 of the storage unit 140 (S04).

FIG. 10 is a diagram showing a data configuration of the coordinatable period 144 and an example of specific data. As described above, the coordinatable period 144 retains the information of the delivery schedules included in the coordinatable period with respect to the coordination-requested delivery schedule. The coordinatable period 144 is formed as a table having the articles same as those of the data configuration of the updated delivery schedule 142 shown in FIG. 7 from which “QUANTITY” is removed.

As a specific method of obtaining the coordinatable period 144, for example, if the case in which the coordination-requested schedule 143 is requested to be coordinated on the “arrival-date basis” shown in the example of FIG. 9 is taken as an example, first, the lead time required for the objective supplier (“SUPPLIER P”) to transport the objective part (“PART X”) by each transportation means with respect to coordination requested “FACTORY A” is obtained from the transportation lead time 301 (in the example of the transportation lead time 301 of FIG. 6, “35 DAYS” in the case of “SHIP”, and “4 DAYS” in the case of “BY AIR”). The latest shipment date of every transportation means is calculated by counting backward from the coordination requested date (in the example of FIG. 9, “April 25”).

Then, regarding the other factories (“FACTORY B”, “FACTORY C”, etc.) other than the coordination-requested factory, the delivery schedules which are the shipment plans before the above-described latest shipment date are extracted from the updated delivery schedule 142. In the example of the updated delivery schedule 142 shown in FIG. 7, regarding the “FACTORY B” and “FACTORY C”, the delivery schedule in which the shipment date is before “March 21” which is 35 days before “April 25” is extracted if the transportation means is “SHIP”, the delivery schedule in which the shipment date is before “April 21” which is 4 days before “April 25” is extracted if the transportation means is “BY AIR”, and the schedules are stored in the coordinatable period 144 after removing the article of “QUANTITY” therefrom. When the information of the coordinatable period 144 is retained, the user can be enabled to easily understand the range of the coordinatable period of the delivery schedules by, for example, displaying this information in the screen or the like shown in FIG. 8.

Returning to FIG. 3, then, based on the factory stock forecast 145 of the storage unit 140 and the transportation lead time 301 and the procurement lead time 302 of the various masters 150, the available-stock calculating unit 133 of the computation unit 130 executes an available-stock calculating process of calculating when and how many stocks can be used (in other words, an amount of margin of the stocks in each factory) among the stocks of the objective parts in each factory and storing that in the available stock 147 of the storage unit 140 (S05).

FIG. 11 is a diagram showing a data configuration of the factory stock forecast 145 and an example of specific data. The factory stock forecast 145 retains information of the forecast about when and how many parts are to be owned by each factory as stocks about each item. The factory stock forecast 145 is formed as a table having articles such as “FACTORY”, “ITEM”, “SUPPLIER”, “DATE”, and “QUANTITY”. The article of “DATE” retains information of objective date of the stock forecast. The article of “QUANTITY” retains information of the quantity forecasted to be owned as stocks.

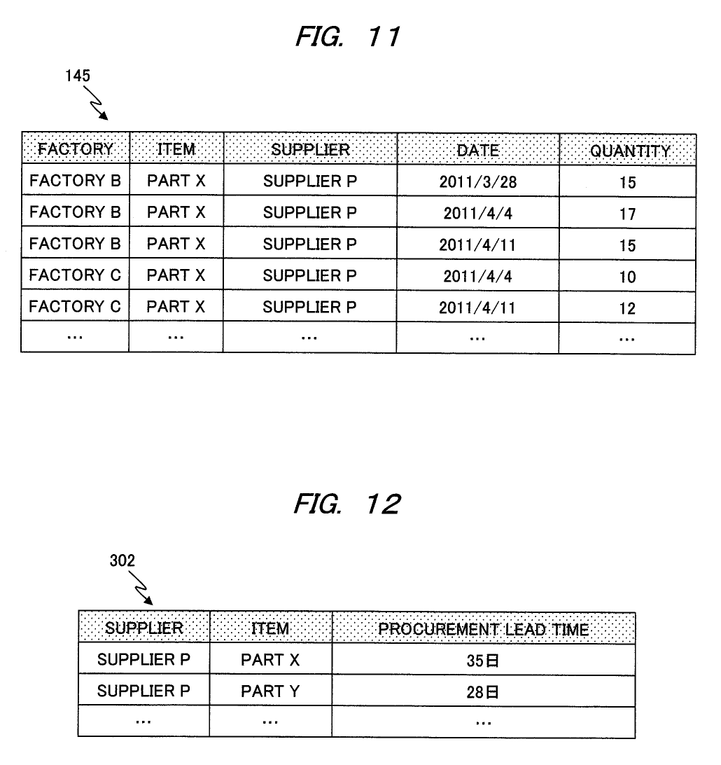

FIG. 12 is a diagram showing a data configuration of the procurement lead time 302 and an example of specific data. The procurement lead time 302 retains information defining a lead time taken from when the supplier receives an order, procures materials, etc., and manufactures the part and until shipping the part. The lead time 302 is formed as a table having articles such as “SUPPLIER”, “ITEM”, and “PROCUREMENT LEAD TIME”. The article of “PROCUREMENT LEAD TIME” retains the information of the lead time taken from when the supplier procures the material, etc. of the objective part and manufactures the part and until the part is shipped.

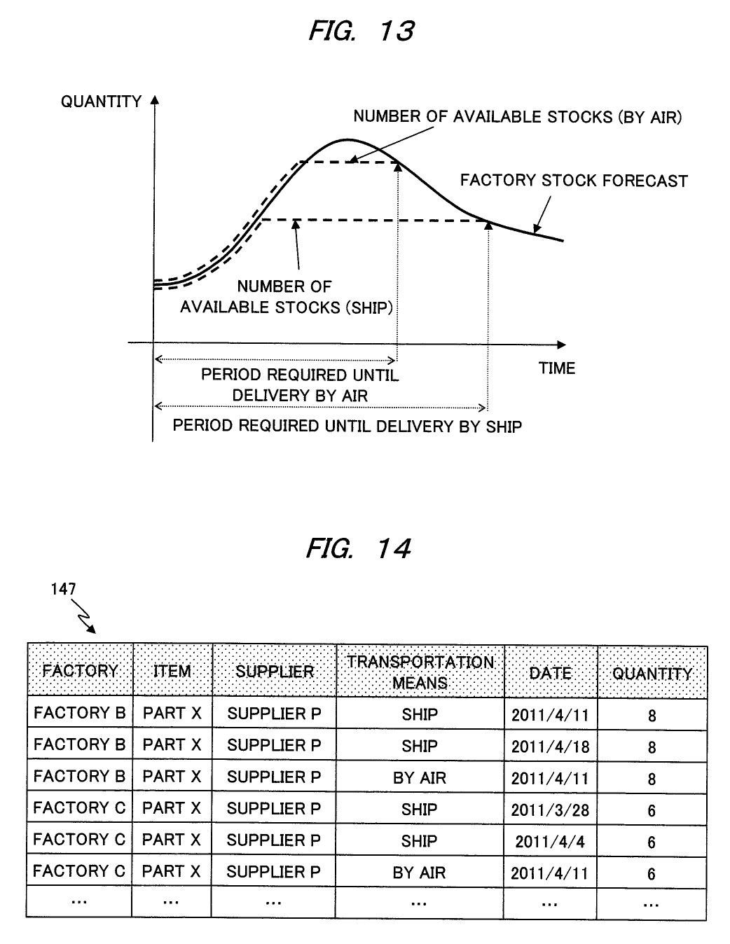

FIG. 13 is a diagram showing an outline of an example of a method of calculating the available stocks in step S05 of FIG. 3. In the graph shown in FIG. 13, time (date) is shown in the horizontal axis, and the quantity of parts is shown in the vertical axis to show the transition of the stock forecast of the parts in the objective factory obtained from the factory stock forecast 145. Herein, in order to obtain the available stocks serving as the amount of margin in the stock forecast, first, a period in which the delivery schedule cannot be coordinated has to be obtained. The period during which the delivery schedule cannot be coordinated is obtained based on: the procurement lead time, which is required for the supplier to procure the materials, etc. of the objective part for each item and manufacture and ship the part; the transportation lead time, which is taken from when the supplier ships the part until the part is delivered to a factory, and the information of transportation means.

For example, in the case in which two types, i.e., by air (high-speed transportation means) and ships (low-speed transportation means) can be used as the transportation means, as shown in FIG. 13, the period in which the delivery schedule cannot be coordinated (in other words, a period necessary until the part newly ordered at the current point is delivered to the factory) is a period obtained by adding the transportation lead times of each of by air and ships to the procurement lead time of the part. Therefore, in the case by air, the period during which the delivery schedule cannot be coordinated is shorter than the case of ships.

The number of the stock forecast in the factory where the number of the stock forecast in the factory at the point of elapse of the delivery-schedule non-coordinatable period serves as an upper limit (the number shown by a dotted line in FIG. 13) is the number of the available stocks during the period. Regarding the period ahead of the delivery schedule non-coordinatable period, if only a necessary number of parts can be newly ordered at the current point or after that, a limitation on the quantity of the available stocks is eliminated. Therefore, normally, the number of available stocks is increased in the case by air.

FIG. 14 is a diagram showing a data configuration of the available stocks 147 and an example of specific data. The available stocks 147 retains information about when and how many available stocks are provided by every transportation means regarding each item in each factory (information of the transition of the number of available stocks as shown in FIG. 13). The available stocks 147 is formed as a table having items such as “FACTORY”, “ITEM”, “SUPPLIER”, “TRANSPORTATION MEANS”, “DATE”, and “QUANTITY”. As the article of “DATE”, information of an objective date of the available stocks is obtained. As the article of “QUANTITY”, information of quantity of the available stocks of an objective part is retained.

Returning to FIG. 3, then, based on the information of the coordinatable period 144 and the available stocks 147, the coordinatable-schedule calculating unit 134 of the computation unit 130 executes a coordinatable-schedule calculating process of calculating a coordinatable number about each delivery schedule of the coordinatable period 144 and storing that as the coordinatable schedule 148 in the storage unit 140 (S06). Herein, regarding each delivery schedule included in the coordinatable period 144, the number of available stocks on each arrival date is obtained from the available stocks 147 and added to be stored as the coordinatable schedule 148.

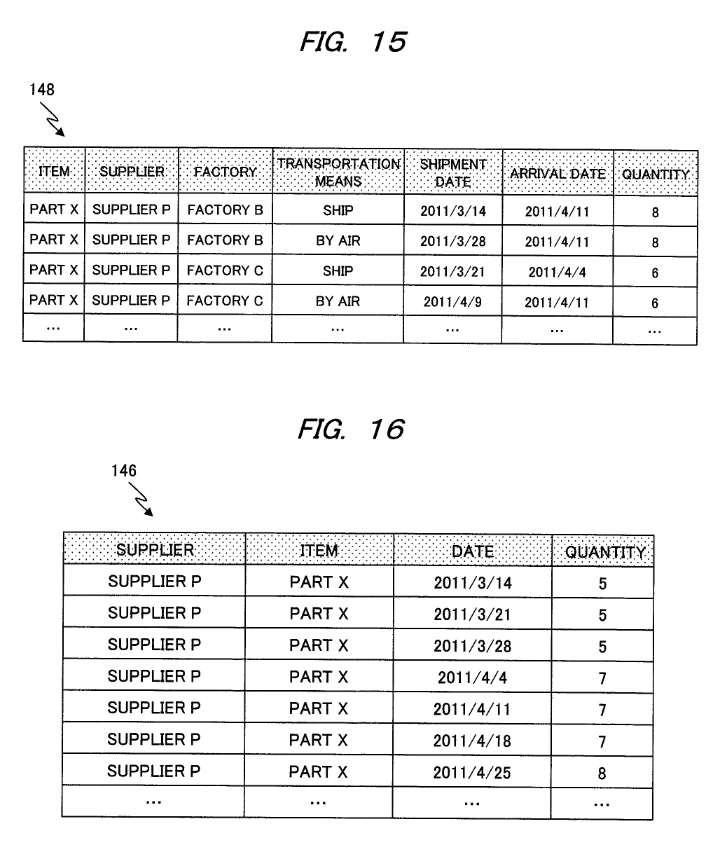

FIG. 15 is a diagram showing the data configuration of the coordinatable schedule 148 and an example of specific data. As described above, the coordinatable schedule 148 retains information of a coordinatable number about each delivery schedule of the coordinatable period 144. The coordinatable schedule 148 is formed as a table having the article of “QUANTITY” in addition to the data configuration similar to the coordinatable period 144 shown in FIG. 10. The article of “QUANTITY” retains the information of the coordinatable quantity about the objective delivery schedule (in other words, the number of available stocks showing an amount of margin of the stocks in the factory of the delivery destination).

Together with the information of the supplier stock schedule 146, the information of the coordinatable schedule 148 is output to a screen with respect to the user by the output unit 124 of the control unit 120 so that the coordinatable delivery schedule can be checked in parallel with respect to the information of the updated delivery schedule 142 based on the two types of timing, i.e., “arrival-date basis” and “shipment-date basis”. Thus, the user can easily understand the ranges of the delivery schedule coordinatable period and the quantity.

FIG. 16 is a diagram showing a data configuration of the supplier stock schedule 146 and an example of specific data. The supplier stock schedule 146 retains information about each item about when and how many parts are planned to be owned as stocks by suppliers (in other words, an amount of margin of the stocks in the suppliers). The supplier stock schedule 146 is formed as a table having articles such as “SUPPLIER”, “ITEM”, “DATE”, and “QUANTITY”. The article of “DATE” retains information of an objective date of stock plans. The article of “QUANTITY” retains information of quantity planned to be owned as stocks.

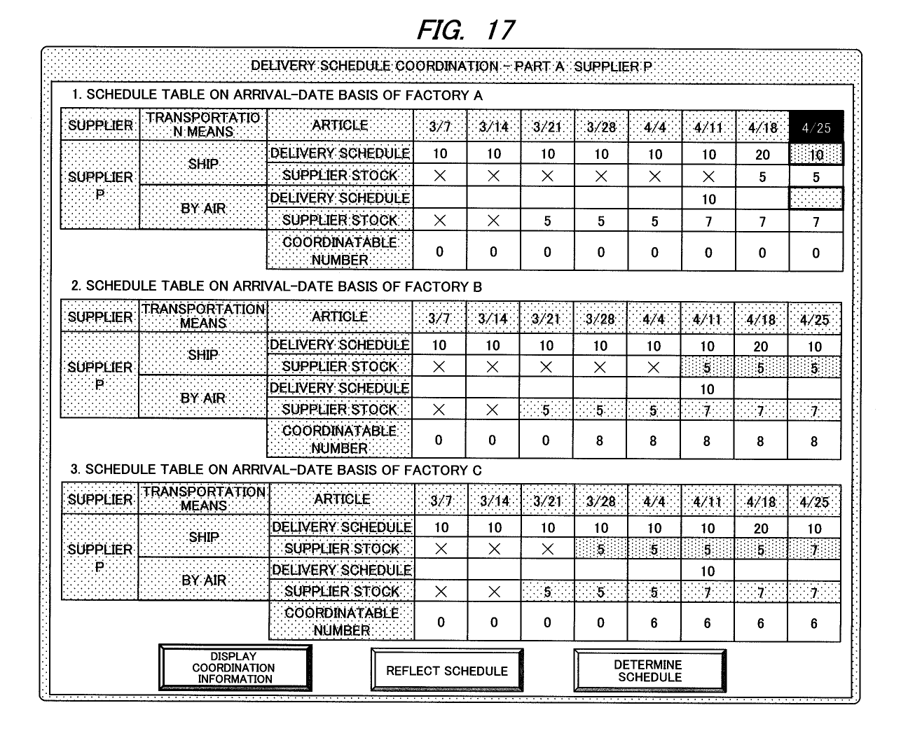

FIG. 17 is a diagram showing an example the delivery schedule coordinating screen for checking and coordinating the delivery schedules. Herein, for example, in the same manner as the screen example of FIG. 8, regarding the schedules of delivery of from the supplier (for example, “SUPPLIER P”) specified for the part (for example, “PART A”) specified by the user, the delivery schedules on the “arrival-date basis” are displayed with respect to each of the factories (and with respect to each of transportation means) in schedule tables of 1 to 3 sequentially from the top. A coordination-requested date (“April 25”) specified by the user in the screen example of FIG. 8 is displayed in an emphasized manner.

Furthermore, as coordination information, a section of “SUPPLIER STOCKS” is added to the delivery schedules, and the information of the quantity of the supplier stock schedule 146 is displayed to correspond to a date that is advanced by the number of days of the lead time of respective transportation means in the transportation lead time 301, thereby enabling understanding of the amount of margin of the stocks of the suppliers. Moreover, a section of “COORDINATABLE NUMBER” is added to display the information of the quantity of the coordinatable schedule 148 calculated in step S06. Therefore, the coordinatable quantity in the delivery schedules with respect to the coordination objective factories (in the example of FIG. 17, “FACTORY B” and “FACTORY C”) can be understood.

Furthermore, regarding these sections, the range of the coordinatable period can be easily distinguished when the section corresponding to the arrival date in each delivery schedule of the coordinatable period 144 is colored with respect to each of the transportation means. Thus, the user can easily understand, for example, when and how much the shipment from the supplier can be increased/reduced in the delivery schedules with respect to the factories in order to satisfy coordination requests.

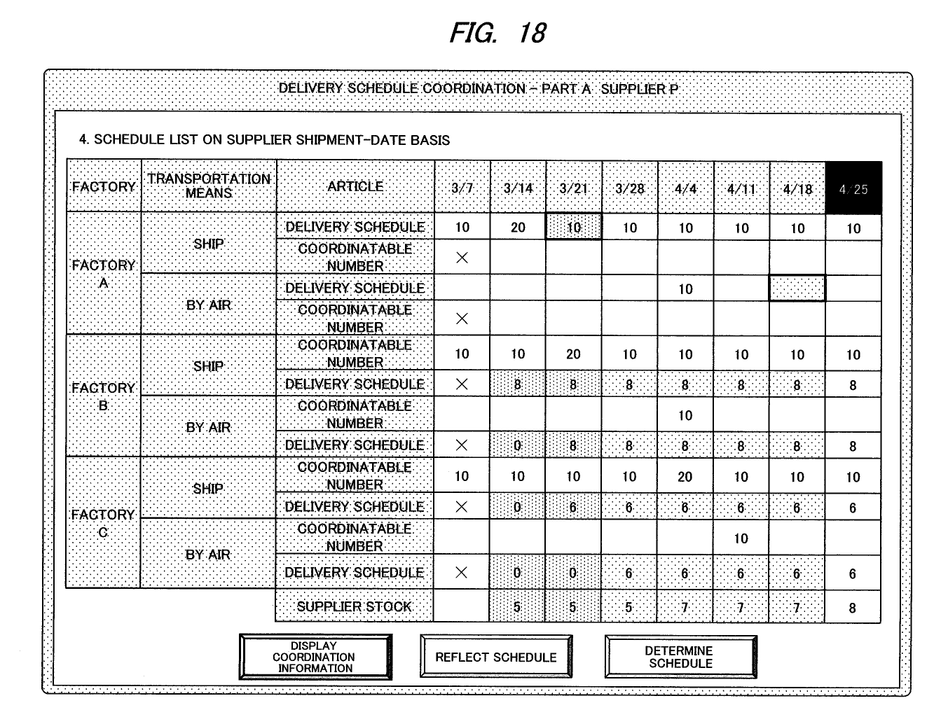

In the same manner, FIG. 18 is a diagram showing another example of the delivery schedule coordinating screen for checking and coordinating delivery schedules. Herein, for example, as well as the screen examples of FIGS. 8 and 17, regarding the schedules of delivery from the suppliers specified for the parts specified by the user, the delivery schedules on “shipment-date basis” are displayed in a list with respect to each of factories in a schedule list table of 4.

Furthermore, a section of “COORDINATABLE NUMBER” is added to the delivery schedules as coordination information, and the information of the quantity of the coordinatable schedule 148 calculated in the step S06 is displayed to correspond to the date reversed by the number of the days of the lead time of respective transportation means in the transportation lead time 301 so that the coordinatable quantity in the delivery schedules with respect to coordination objective factories (in the example of FIG. 18, “FACTORY B” and “FACTORY C”) can be understood. Moreover, a section of “SUPPLIER STOCK” is added to display the information of the quantity of the supplier stock schedule 146 so that the amount of margin of the stocks of the supplier can be understood.

Furthermore, in the same manner as the screen example of FIG. 17, regarding these sections, the sections corresponding to the shipment date in each delivery period of the coordinatable period 144 are, for example, colored so that the range of the coordinatable period can be easily distinguished. By virtue of these, the user can easily understand, for example, when and how much the shipment from the supplier can be increased/reduced in the delivery schedule with respect to each factory in order to satisfy coordination requests. In the examples of FIGS. 17 and 18, the delivery schedules on the “arrival-date basis” and the delivery schedules on the “shipment-date basis” are configured to be switched and displayed by different screens; however, for example, as shown in the screen example of FIG. 8, the schedules may be displayed so as to be viewed in the same screen.

Returning to FIG. 3, then, the schedule-change-information receiving unit 123 of the control unit 120 executes a schedule-change-information receiving process of receiving information of changed contents of the coordination-requested delivery schedules from the user via the delivery schedule coordinating screen as shown in FIG. 17 or 18 (S07). Herein, for example, in the delivery schedule coordinating screen shown in FIG. 17 or 18, when a “REFLECT SCHEDULE” button in the lower part of the screen is touched after changed contents of the delivery schedules are input by the user, the information of the changed contents is received.

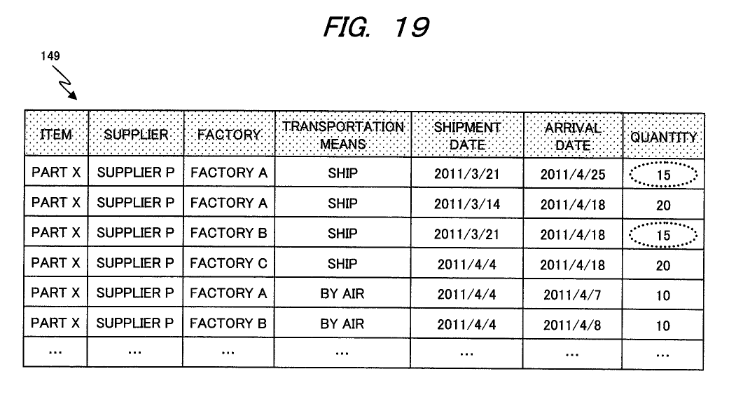

Then, the schedule-change reflecting unit 135 of the computation unit 130 executes a schedule-change reflecting process of reflecting the information of the changed contents received in the step S07 to the delivery schedule and storing that as the changed schedule 149 of the storage unit 140 (S08). FIG. 19 is a diagram showing the data configuration of the changed schedule 149 and an example of specific data. As described above, the changed schedule 149 retains information of the delivery schedules to which the contents changed by the user are reflected. The changed schedule 149 is formed as a table having a data configuration same as that of the updated delivery schedule 142 shown in FIG. 7.

The example of FIG. 19 shows the case in which, in the example of the updated delivery schedule 142 shown in FIG. 7, the delivery schedules are changed so that the quantity “20” of the schedule of the delivery shipped on “March 21” by “SHIP” from “SUPPLIER P” and arrived at “FACTORY B” on “April 18” is reduced by “5”, and the quantity “10” of the schedule of the delivery shipped on “March 21” and arrived at “FACTORY A” on “April 25” is increased by “5”. The information of the changed schedule 149 is output by the screen to the user by the output unit 124 of the control unit 120 so that the changed results of the delivery schedules can be checked, for example, via a delivery schedule coordinating screen same as that shown in FIG. 8.

Returning to FIG. 3, then, in order to evaluate the degree of influence caused by coordination of the delivery schedules, in accordance with needs, based on the information such as the updated delivery schedule 142, the changed schedule 149, the factory stock forecast 145, the supplier stock schedule 146, and the transportation cost 303, the KPI calculating unit 136 of the computation unit 130 executes a KPI calculating process of calculating KPI (S09). As the KPI, the contents thereof are not limited as long as it is an index that enables quantitative evaluation and understanding of the influence caused by a change in the delivery schedules, and thus an arbitrary index can be used.

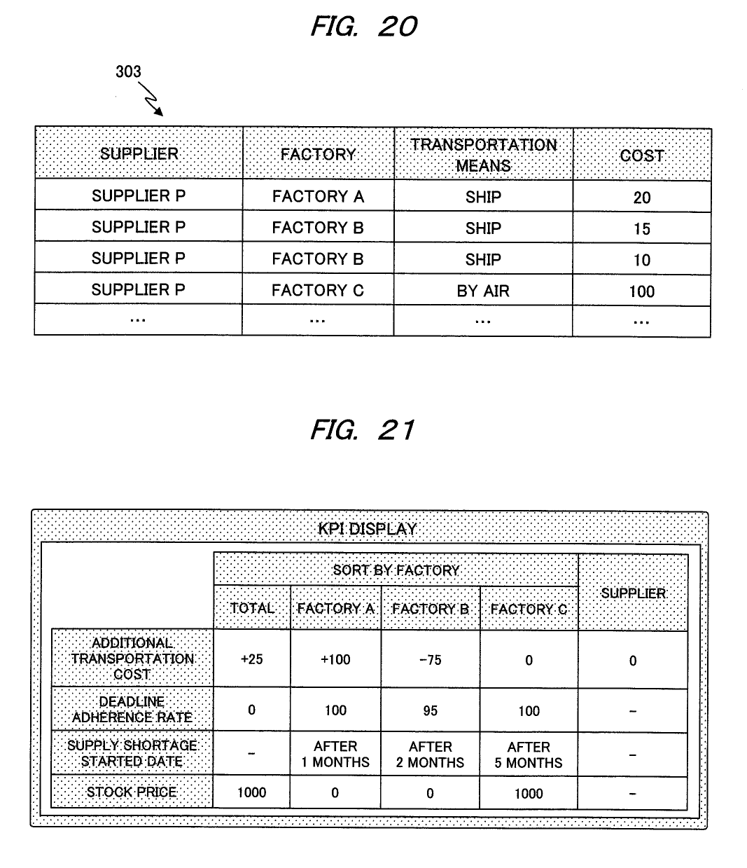

For example, based on information or the like of the transportation cost 303 obtained from the external information 300 and retained in the various masters 150 of the storage unit 140, increase/reduction in the transportation cost as a whole can be obtained and used as an index. FIG. 20 is a diagram showing a data configuration of the transportation cost 303 and an example of specific data. The transportation cost 303 retains information defining cost, which is taken upon transportation from each supplier to each factory, with respect to each of transportation means. The transportation cost 303 is formed as a table having articles such as “SUPPLIER”, “FACTORY”, “TRANSPORTATION MEANS”, and “COST”. The article of “COST” retains information about cost required upon transportation from the supplier to the factory by the objective transportation means.

The information of the calculated KPI is output by screen by the output unit 124 of the control unit 120. FIG. 21 is a diagram showing an example of a KPI display screen for displaying KPI. As shown in the drawing, various things such as an adherence rate of deadline of the parts, presence/absence of occurrence of supply shortage and a period thereof, and cost about stock maintenance are conceivable as the KPI in addition to increase/reduction in the transportation cost as a whole. When the user checks the contents of KPI by the screen, the degree of influence to each factory and each supplier caused by the change in the delivery schedules can be checked comprehensively, and the determination whether the change in the delivery schedules is to be implemented or not can be instantly determined.

When the user determines as a result that the changed contents of the delivery schedule are to be determined, a “DETERMINE SCHEDULE” button in the example of the delivery schedule coordinating screen shown in FIG. 8, FIG. 17 or 18 is touched. As a result, in the process flow of FIG. 3, the schedule-change determining unit 137 of the computation unit 130 executes a schedule-change determining process of reflecting the contents of the changed schedule 149 of the storage unit 140 to each of the delivery schedule 141 and the updated delivery schedule 142 and determining the delivery schedules (S10). The contents of the delivery schedule 141 or the updated delivery schedule 142, of which change has been determined, may be output, for example, via the screen as shown in FIG. 8 by the output unit 124 of the control unit 120. The purchase supervisor, a person in charge in each supplier, etc. can receive the information also, for example, by downloading via the communication unit 110 and the network 200.

As described above, according to the device for supporting goods delivery schedule coordination 100 which is the embodiment of the present invention, the purchase supervisor can check the delivery schedules by the two types of timing (“shipment-date basis” and “arrival-date basis”) of the date of shipment from the supplier and the date of arrival at the factory by referencing the delivery-schedule coordinating screen as shown in FIG. 8.

Upon reviewing of the coordination of the delivery schedules, after the information of the necessary amount, amount of margin, and delivery schedule of the parts at each factory on the “arrival-date basis” and the information of the schedule of shipment from each supplier and shipping ability on the “shipment-date basis” are organically associated with each other, whether the objective delivery schedule is executable or how large the coordinatable range is can be automatically determined and presented to the user. Furthermore, even when the contents of the change in the delivery schedules are input by using either one of the two types of delivery schedule coordinating screens of “shipment-date basis” and “arrival-date basis” as shown in FIGS. 17 and 18, the user can check the influence of the change instantly by outputting the influence on other schedules caused thereby by using the two types of delivery schedule coordinating screens and using the screen display screen or the like as shown in FIG. 21.

By virtue of these, the purchase supervisor can be supported to plan/coordinate the delivery schedule of high accuracy in a short period of time.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, the present embodiment has been described on the assumption that the number of the supplier is one. However, the embodiment may be implemented using a plurality of suppliers as targets. In that case, even if the delivery schedule in a certain supplier cannot be coordinated, whether the coordination can be implemented by the other suppliers or not can be reviewed; therefore, the objective range in which the delivery schedules can be coordinated is expanded, and the coordination of the delivery schedule further meeting the demands of the purchase supervisor can be carried out.

In the present embodiment, the purchase supervisor has been described as the user; however, the embodiment can be implemented by a person in charge at the supplier, and, furthermore, it is also possible to implement the embodiment both by the purchase supervisor and the person in change at the supplier. Particularly when the person in charge at the supplier that supplies parts to a plurality of factories or clients carries out operations using the device for supporting goods delivery schedule coordination 100 of the present embodiment, for example, the contents of the change in the delivery schedule made by the purchase supervisor can be instantly understood by the person in charge at the supplier, it is extremely effective since the delivery state can be checked in parallel at the two types of timing of “shipment-date basis” at the supplier and “arrival-date basis” at the factory (client), and the deadline adherence rate can be improved.

In the present embodiment, in the examples of the delivery schedule coordinating screens shown in FIG. 8 and FIGS. 17 and 18, the information of the delivery schedule coordinatable period, the coordinatable number (the amount of margin of the stocks at the delivery-destination factory), and the number of supplier stocks (an amount of margin of the stocks at the supplier) is displayed; however, only part of these articles may be obtained and displayed.

Moreover, in the present embodiment, changing the delivery schedule has been described as an object. However, it is also possible to check the range of influence on the delivery schedule by increasing/reducing the quantity of the supplier stock schedule 146 or the factory stock forecast 145. For example, with respect to increase/reduction in the quantity of the supplier stock schedule 146 or the factory stock forecast 145, the objective date thereof is specified by the user via the delivery schedule coordinating screen as shown in FIG. 8 or FIG. 17 or 18. Based on this information, the schedule-coordinatable-period calculating unit 132 of the computation unit 130 can calculate the period that affects the delivery schedule, and the output unit 124 of the control unit 120 can display the period as an influence range via the delivery schedule coordinating screen as shown in FIG. 17 or 18.

Moreover, in the present embodiment, the operations of managing delivery of parts to factories have been explained as examples. However, the object of application is not limited thereto. The embodiment can be applied to, for example, a purchase operation or an order-placement/reception managing operation in the distribution mode in which one or more suppliers deliver goods to one or more delivery destinations.

The present invention can be used in a device for supporting goods delivery schedule coordination and a program of supporting goods delivery schedule coordination for planning/coordinating delivery schedules about delivery of goods from a supplier to a delivery destination.

What is claimed is:

1. A device for supporting goods delivery schedule coordination supporting coordination of a delivery schedule about delivery of goods from a supplier to a delivery destination, the device comprising:
a storage unit retaining
information of the delivery schedule about when and how many of the goods are planned to be delivered to the delivery destination by the supplier, and
information of transportation lead time defining, with respect to each of transportation means, a lead time taken upon transportation of the goods from the supplier to the delivery destination;
a computation unit having a transportation lead-time converting unit
calculating a shipment date by counting backward from a date of arrival at the delivery destination in the delivery schedule by a number of days of the corresponding transportation lead time based on the information of the delivery schedule and the information of the transportation lead time, and
adding the information of the calculated shipment date to the delivery schedule and storing the information into the storage unit as an updated delivery schedule; and
a control unit having
an output unit outputting by a screen the information of the updated delivery schedule based on two types of timing of arrival-date basis regarding when the goods arrive at the delivery destination and shipment-date basis regarding when the goods are shipped from the supplier, and
a schedule-coordination-information receiving unit receiving from a user the information of the delivery schedule for which coordination is requested via the screen and storing the information of the delivery schedule into the storage unit as a coordination requested schedule,
the computation unit further having a schedule-coordinatable-period calculating unit
calculating a period coordinatable with respect to the delivery schedule for which coordination is requested by the user based on the information of the updated delivery schedule, the information of the coordination requested schedule, and the information of the transportation lead time,
extracting the delivery schedule included in the period, and
storing the extracted schedule into the storage unit as a coordinatable period; and
the output unit of the control unit displaying a range about the coordinatable period distinguishably on the screen.

2. The device for supporting goods delivery schedule coordination according to claim 1, wherein
the storage unit further retains
information of delivery destination stock forecast that is a forecast about when and how many of the goods are to be owned as a stock in the delivery destination, and
information of procurement lead time defining a lead time taken from when the supplier receives an order until the goods are shipped;
the computation unit further has
an available-stock calculating unit calculating when and how many of the stock of the goods in the delivery destination is available based on the information of the delivery-destination stock forecast, the information of the transportation lead time, and the information of the procurement lead time and storing that into the storage unit as a available stock, and
a coordinatable-schedule calculating unit storing information obtained by calculating and adding a coordinatable number about the delivery schedule in the coordinatable period based on the information of the coordinatable period and the information of the available stock into the storage unit as a coordinatable schedule; and
the output unit of the control unit outputs, by the screen, the information of the coordinatable schedule so as to correspond to the information of the updated delivery schedule based on the two types of timing of the arrival-date basis and the shipment-date basis.

3. The device for supporting goods delivery schedule coordination according to claim 1, wherein
the storage unit further retains information of a supplier stock schedule about when and how many of the goods are planned to be owned as a stock by the supplier; and
the output unit of the control unit outputs, by the screen, the information of the supplier stock schedule so as to correspond to the information of the updated delivery schedule based on the two types of timing of the arrival-date basis and the shipment-date basis.

4. The device for supporting goods delivery schedule coordination according to claim 1, wherein
the control unit further has a schedule-change-information receiving unit receiving, from the user, information of a changed content of the delivery schedule for which coordination is requested via the screen;
the computation unit further has
a schedule-change reflecting unit reflecting the information of the changed content to the delivery schedule and storing the delivery schedule into the storage unit as a changed schedule, and
a KPI calculating unit of calculating an index quantitatively evaluating influence of the change in the delivery schedule based on the information including the updated delivery schedule and the changed schedule; and
the output unit of the control unit outputs, by the screen, the information of the changed schedule based on the two types of timing of the arrival-date basis and the shipment-date basis and further outputs, by the screen, the index calculated by the KPI calculating unit.

5. The device for supporting goods delivery schedule coordination according to claim 1, wherein
both a person in charge of supervising management of the delivery schedule and a person in charge in the supplier can carry out a process of checking and coordinating the delivery schedule.

6. The device for supporting goods delivery schedule coordination according to claim 2, wherein
the schedule-coordination-information receiving unit receives, from the user, the information of the delivery-destination stock forecast requested to be changed;
the schedule-coordinatable-period calculating unit of the computation unit calculates a period affecting the delivery schedule with respect to the delivery-destination stock forecast requested to be changed by the user based on the information of the updated delivery schedule, the information of the delivery-destination stock forecast requested to be changed, and the information of the transportation lead time; and
the output unit of the control unit outputs, by the screen, the information of the period affecting the delivery schedule so as to correspond to the information of the updated delivery schedule based on the two types of timing of the arrival-date basis and the shipment-date basis.

7. The device for supporting goods delivery schedule coordination according to claim 3, wherein
the schedule-coordination-information receiving unit receives, from the user, the information of the supplier stock schedule requested to be changed;
the schedule-coordinatable-period calculating unit of the computation unit calculates a period affecting the delivery schedule with respect to the supplier stock schedule requested to be changed by the user based on the information of the updated delivery schedule, the information of the supplier stock schedule requested to be changed, and the information of the transportation lead time; and
the output unit of the control unit outputs, by the screen, information of a period affecting the delivery schedule so as to correspond to the information of the updated delivery schedule based on the two types of timing of the arrival-date basis and the shipment-date basis.

8. A method of supporting goods delivery schedule coordination using a device for supporting goods delivery schedule coordination, the device supporting coordination of a delivery schedule about delivery of goods from a supplier to a delivery destination, the method executing:
based on information of the delivery schedule about when and how many of the goods are planned to be delivered to the delivery destination by the supplier and information of a transportation lead time defining, with respect to each of transportation means, a lead time taken upon transportation of the goods from the supplier to the delivery destination, a transportation lead time converting step of
calculating a shipment date by counting backward from a date of arrival at the delivery destination in the delivery schedule by a number of days of the corresponding transportation lead time, and
adding the information of the calculated shipment date to the delivery schedule and storing the information as an updated delivery schedule;
a schedule-coordination-information receiving step of
outputting, by a screen, the information of the updated delivery schedule based on two types of timing of arrival-date basis regarding when the goods arrive at the delivery destination and shipment-date basis regarding when the goods are shipped from the supplier,
receiving, from a user, the information of the delivery schedule for which coordination is requested via the screen, and
storing the information of the delivery schedule as a coordination requested schedule;
a schedule-coordinatable-period calculating step of
calculating a period coordinatable with respect to the delivery schedule for which coordination is requested by the user based on the information of the updated delivery schedule, the information of the coordination requested schedule, and the information of the transportation lead time,
extracting the delivery schedule included in the period, and
storing the extracted schedule as a coordinatable period,
the method displaying a range about the coordinatable period distinguishably in the screen.

9. The method of supporting goods delivery schedule coordination according to claim 8, the method further executing:
based on information of delivery destination stock forecast that is a forecast about when and how many of the goods are to be owned as a stock in the delivery destination, information of a procurement lead time defining a lead time taken from when the supplier receives an order until the goods are shipped, and the information of the procurement lead time,
an available-stock calculating step of calculating when and how many of the stock of the goods in the delivery destination is available and storing the same as a available stock; and
a coordinatable-schedule calculating step of storing information obtained by calculating and adding a coordinatable number about the delivery schedule in the coordinatable period based on the information of the coordinatable period and the information of the available stock as a coordinatable schedule,
the method outputting the information of the coordinatable schedule by the screen so as to correspond to the information of the updated delivery schedule based on the two types of timing of the arrival-date basis and the shipment-date basis.

10. The method of supporting goods delivery schedule coordination according to claim 8, wherein
information of a supplier stock schedule about when and how many of the goods are planned to be owned as a stock by the supplier is output by the screen so as to correspond to the information of the updated delivery schedule based on the two types of timing of the arrival-date basis and the shipment-date basis.

11. The method of supporting goods delivery schedule coordination according to claim 8, further executing
a schedule-change-information receiving step of receiving, from the user, information of a changed content of the delivery schedule for which coordination is requested via the screen;
a schedule-change reflecting step of reflecting the information of the changed content to the delivery schedule and storing the delivery schedule as a changed schedule; and
a KPI calculating step of calculating an index quantitatively evaluating influence of the change in the delivery schedule based on the information including the updated delivery schedule and the changed schedule,
the method outputting the information of the changed schedule by the screen based on the two types of timing of the arrival-date basis and the shipment-date basis and further outputs, by the screen, the index calculated in the KPI calculating step.
